(19) United States
(12) Patent Application Publication
(10) Pub. No.: US 2010/0099437 A1
(43) Pub. Date: Apr. 22, 2010

(54) Mobile Service For Keeping Track Of Competitors During A Race

(76) Inventor: Adriaan Jan Moerdijk, Rijen (NL)

Correspondence Address: ERICSSON INC., 6300 LEGACY DRIVE, M/S EVR 1-C-11, PLANO, TX, 75024, US

(21) Appl. No.: 12/529,459

(22) PCT Filed: Mar. 1, 2007
(86) PCT No.: PCT/NL2007/050084

§ 371 Date: Dec. 16, 2009

(51) Int. Cl. H04W 24/00; G06F 15/16

(52) U.S. Cl. 455/457; 709/203; 709/206

(57) ABSTRACT

The invention relates to an application server for use in a mobile communication network, the application server being arranged for: —receiving position information on positions of a first mobile terminal; —calculating a distance traveled since a starting time for the first mobile terminal; —comparing the distance traveled with a distance traveled by a competitor to render a relative distance; —sending feedback information to the first mobile terminal relating to the relative distance. The competitor can be based on a real participant that has done the race before (in theory the end-user itself) or a fictitious opponent that was selected on criteria like average speed. The system can be used during races and may provide information to participants, spectators and officials via bill-boards and/or voice messages and/or SMS messages.

### TECHNICAL FIELD

The present invention relates to a mobile service for keeping track of competitors during a race. Racing information can be received through a mobile device (e.g. mobile phone) in order to inform and stimulate a user doing the race.

### BACKGROUND

Recently, Apple™ introduced a mobile music player having a head phone, said music player being arranged to wirelessly communicate with a sensor in a sports shoe.

The sensor records the speed of a runner wearing the sports shoe and sends information to the music player. The music player is especially adapted to process the information received, and to give the user audio information on e.g. the distance lapsed, the time lapsed and the calories burned. After a workout, the user can connect the music player to a computer to upload workout data to a web server application via the Internet. This web application can be used to see previous runs, set targets, and challenge other users. The web application can be used to challenge anyone, anywhere to a so-called virtual race. A user may run on her own time, on her home turf, and then log on to the web application to retrieve the results and compare it with others.

Publications U.S. Pat. No. 6,463,385 B1 describes a sports computer having an integral global satellite positioning (GPS) receiver and a computer interfacing capability that enables functional and/or performance characteristics to be tracked and analyzed as a function of geographical position and/or elevation. The computer includes a mount or interface to one or more sensors to measure operational and/or physiological parameters such as heart rate, or weather conditions such as temperature. Stored geographical and sensor parameters may be downloaded to an external personal computer so that the data collected during a workout may be reviewed and analyzed on the screen of a Personal Computer.

Although the system described in U.S. Pat. No. 6,463,385 B1 is more accurate in recording the distance lapsed than the discussed music player using a sensor in a sports shoe, it also needs an additional computer in order to compare recorded workout data with data of other users. This can only be done after the workout has been finished and not in real-time during an exercise or match.

### SUMMARY OF THE INVENTION

A goal of the present invention is to provide a system and method for recording user activity data during a race and communicating relevant data to the user wherein activity data of one or more other users is communicated to the first user in real time. This goal is achieved by providing an application server for use in a mobile communication network, the application server being arranged for:

receiving position information on positions of a first mobile terminal;
calculating a distance traveled since a starting time for the first mobile terminal;
comparing the distance traveled with a distance traveled by a competitor to render a relative distance;
sending feedback information to the first mobile terminal relating to the relative distance.

The application server may be arranged to perform the steps listed above on a regular basis.

The invention also relates to a mobile communication network comprising the application server as described above.

Finally, the invention relates to a method of executing a mobile service on an application server according to claim 22.

### BRIEF DESCRIPTION OF THE DRAWINGS

The present invention will be discussed in more detail below, using a number of exemplary embodiments, with reference to the attached drawings, in which:

FIG. 1A shows part of a mobile telecommunication network according to an embodiment of the invention;

FIG. 1B shows part of a mobile telecommunication network according another embodiment;

FIG. 2 shows a high level sequence diagram with a possible realization of an opponent service application;

FIG. 3 schematically shows data streams between the opponent service application and a database and a terminal according to an embodiment.

### DETAILED DESCRIPTION

The invention entails a mobile communication system that provides people doing sports (during matches or workouts) with information about other opponents. One example is that during running matches, the system may provide mobile telephone users with information about where a so-called ‘Virtual opponent’ is running (e.g. in front of or behind the end-user) in order to keep a desired pace. The mobile communication system is applicable to many sports, such as sailing events, where the system could provide a boat information on how the actual progress is compared to a desired progress (e.g. the one that is needed to win a race).

In an embodiment, the mobile communication system provides information on real opponents, during a life match or from a match that has already happened (could be that contenders run in sequence or even with a lot of time in between). The mobile communication system could in this way help to create communities, such as people doing mountain-bike tracks that could via the mobile communication system get information on others who have in the past done the track and how they performed. Another example is that the mobile communication system provides information on how the end-user performed last time (e.g. same match one year before).

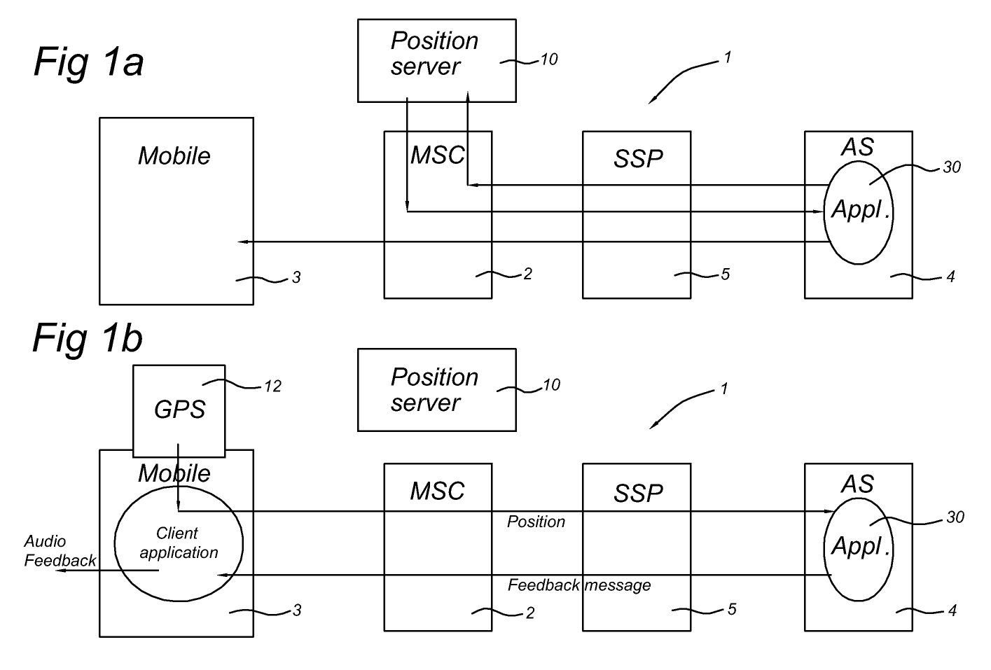

FIG. 1A depicts part of a mobile telecommunication network 1 according to an embodiment of the invention. The mobile communication network 1 comprises an Mobile Switching Center (MSC) 2 that is arranged to set up a connection between a mobile terminal 3 and an Application Server (AS) 4 via a Service Switching Point (SSP) 5. According to an embodiment the application server 4 is arranged to receive an instruction from a user of the mobile terminal 3 for starting an application referred to as ‘Opponent service application’ 30. Once the Opponent service application 30 is started it receives position information on the mobile terminal 3. This position information may be received from a position server 10 that is arranged to determine the actual position of the mobile terminal 3 by using e.g. triangular methods in GSM networks. Alternatively, the position information may be received from the mobile terminal 3 itself, in case the mobile terminal 3 comprises e.g. a GPS receiver 12 as is shown in FIG. 1B.

The application server 4 is arranged to repeatedly calculate a distance traveled since a starting time for the mobile terminal 3. The starting time may be determined by the application server 4 using a trigger signal from the mobile terminal 3. The calculated distance traveled is then compared with at least one distance traveled by a competitor to render a relative distance. Feedback information is sent to the mobile terminal 3 relating to the relative distance.

By sending feedback information back to the mobile terminal 3, the user may be informed in real time about her opponents. This will encourage her to perform better, which is not possible using the state of the art methods. The feedback information may e.g. be sent on regular time intervals, regular space intervals, on request of the user of the mobile terminal 3, or at certain distances. Please note that these possibilities are given as examples and are not in any way limiting the scope of the invention.

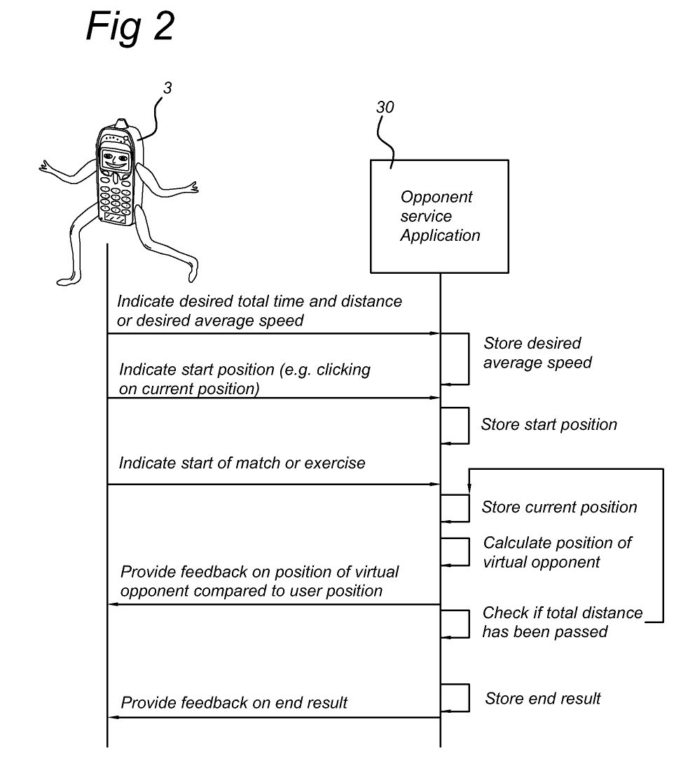

FIG. 2 shows a high level sequence diagram showing a possible realization of an opponent service application. This embodiment realizes a possibility for end-users to compare their own performance with a virtual opponent/sportsman. In a first step, the end-user enters a total desired race time (i.e. workout time) or desired distance or average speed. This information is sent to the opponent service application. The opponent service application stores this information and calculates the desired average speed if necessary. In a next step, the end-user enters a start position e.g. by clicking on “current position” of an interfacing program on the mobile terminal 3. The starting position is stored by the opponent service application. Next, the end-user indicates that she is starting the match or exercise. The opponent service application will now store the current position of the end-user (i.e. of the mobile terminal 3) and also calculate the position of the Virtual opponent by using the average speed entered/calculated. The difference between the Virtual opponent and the terminal 3 is fed back to the terminal 3 by way of a message. This message can be a voice message, audio beeps, an SMS message, or any other suitable message. A voice message may be: “You are 20 meters ahead of your opponent, still 100 meters to go, hold on!”.

Repeatedly, the opponent service application is checking on whether the total distance has been passed. As soon as the total distance has been passed, the end results is stored and communicated to the terminal 3. A possible message may be: “You won, your finishing time is 2 hours 14 minutes 20 seconds, your opponent finished 1 minute 10 seconds later”.

Please note that the opponent service application can be deployed on the mobile terminal 3 carried by the end-user or be deployed in the application server 4 of the mobile communications network 1, see FIG. 1. In the former case the end-user equipment must be able to obtain positions, e.g. via GPS. In the latter case the telecommunications network should be able to obtain the position of the end-user (triangle methods in GSM network) or the end-user equipment should be able to send its position to the network.

Comparable, the audio feedback can be generated by the application server 4 and provided to the mobile terminal 3 like an ordinary call. Alternatively a client part of a client server application in the mobile terminal 3 can translate non audio messages from the server application 30 into audio feedback. This type of client application can be downloaded to the mobile by means of connecting the mobile device to a personal computer and then downloading the application from the internet or by means of the OTA (over the air application download) well known to skilled person.

There are several alternatives to implement feedback provided to the mobile terminal 3 on the position of a (virtual) opponent compared to the terminal's position. In an embodiment, audio beeps are generated to indicate the relative distance between the mobile terminal 3 and the (virtual) opponent. The audio beeps can be generated using different frequencies in order to produce the well known Doppler effect. Several alternatives are possible such as:
High pitch beep when opponent is closing in, Low pitch beep when distance increases,
High pitch beep when behind on opponent, Low pitch beep when in front.

A beep interval may be based on the time to catch up on the opponent. Practical beep intervals from 10 beeps per second till 1 beep per 5 seconds.

A possible discrimination of the beep frequencies (i.e. pitch) may be greater than two times the difference in beep frequency.

During a race, the actual distance in meters or seconds may be fed back to the end-user by way of e.g. a voice message. Also additional feedback can be provided to the user like current speed, average speed. If a distance message is given, the time interval of consecutive messages may be fixed (user may select interval of 1 sec, 10 sec, 1 minute, 10 minutes) or variable based on a distance to catch-up. For example, the frequency of the messages may increase when the opponent is catching up.

The end-result feedback can be in several forms, e.g. a popup on the end-user device or an SMS provided by the telecommunications network. The feedback should show a comparison with how the end-user performed compared to the virtual opponent during the whole track. There could also be a comparison with already stored results from the same track indicating day/time etcetera.

In an embodiment, the opponent service application detects the presence on the starting point or a passing of the finish point and an audio feedback is given. When starting also a countdown beep series can be given to simulate start sequence.

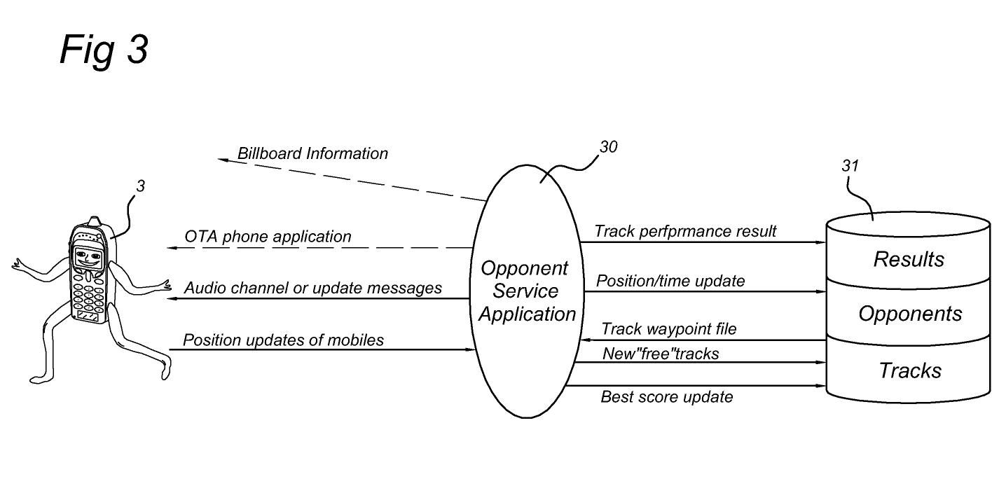

In an embodiment, the opponent service application 30, see FIG. 3, is arranged to retrieve information from a database 31. In the database 31, information is stored on tracks, results of users, information on opponents, etcetera. By means of the mobile terminal 3, the end-user is able to select an existing track and the opponent service application 30 detects that the end-user passes the start line and finish line of an existing track (e g running half a marathon). The end-user may be given the possibility to select an opponent based on someone that already has done the race, in theory the end-user itself (e.g. results of last year's match). The database 31 may comprise information on tracks and people that have done the tracks.

As can be seen from FIG. 3, the opponent service application 30 receives position updates from the mobile terminal 3. These updates may be forwarded to the database 31 for storage. The opponent service application 31 is arranged to retrieve track waypoint files from the database 31. These track waypoint files comprise data on how an opponent performs (or performed) on the track chosen. These data are used by the opponent service application 31 together with the position updates it received form the terminal 3, to calculate the relative distance traveled. This calculated value is then sent to the mobile terminal 3 via an audio channel or text messages. The opponent service application 31 also sends track performance data to the database 31. This information can be used to be compared with other users that may be using the opponent service application 30 at present or in the future. In case the opponent service application 30 is prompted by the terminal 3 that the user starts a new track, the position updates are registered and sent to the database 31 as being a new track. Once an end-user has finished a track, a best score is updates to the database 31 if applicable.

As already mentioned above, the opponent service application may be deployed on the end-user device (i.e. the mobile terminal 3). In this case, it is possible to download the existing track information (way points) and the information of an opponent from the database 31 to the mobile terminal 3.

Please note that the invention gives a user the opportunity to race an opponent during an actual race, but also during the whole year when the race is not ‘on’.

Several categories of tracks may be defined, the results of which may be stored in the database 31 depending on the category and the end results.

### Private Tracks Versus Public Tracks

Private tracks are for the end-user, and can be given to others to compete against, but their best time will not be stored, only when the end-user herself improves the best time it will be stored.
Open track, everybody who improves the best time will be stored.
Public track, the result of everybody is stored and can be used to calculate top, average and lower, or other categories like Olympic, national, . . . , beginners.

### Fixed Track Versus Free Track

Fixed tracks are preprogrammed tracks. This opens possibility to provide items like the usage of billboards at start points that inform end-users on the track details and how to start the opponent service. As mostly these will be public tracks it might also give the end-user options to select options like category; best or slowest to compete against. It also provides possibilities like an electronic bill board for name scoring at the finish.
A free track can be started by anybody; the first time a start and end of the track must be signaled to the opponent service, and no tactile feedback is given as the track is recorded for the first time. A second time the track is done, the end-user will get the feedback.

A stored track can also be used in opposite direction. This can be done by just reversing the order of measured position time points but also more intelligent by reversing the pattern as well to incorporating dips, end spurts etcetera. This also depends largely on how track information is stored. A track can be stored by regarding a track as being a sequence of way points. A track can be stored as fixed positions (i.e. way point) with variable time (referred to as fixed position storage) or as fixed time intervals with variable positions (referred to as fixed time storage). The fixed time interval storage makes the use of reverse track easier and more intelligent but interpolation of intermediate positions is required. With fixed position storage, the reverse track requires interpolation of time. In general, fixed time interval storage is advisable as the same mechanism can be used for different speed categories. Like running compared to bicycling where in fixed position storage the density of positioning points must be adapted to encompass the difference in average speed.

The fixed time storage has a further advantage that during the race the fixed time points give a “heartbeat” on which the opponent service application 30 will check the mobile's position to the stored track position, calculate the distance between them, and set an updated value for the feedback. Alternatively the “heartbeat” can be implemented in the client application in the mobile terminal 3 that then will provide GPS measured position to the server application on each “heartbeat”.

Decoupling of the “heartbeat” from how frequently feedback is provided also provides additional possibilities to vary the feedback frequency on the basis of the distance (in time or actual distance) to the opponent. This will create an even greater user experience.

In an embodiment, when a position of the terminal 3 is returned to the opponent service application that is too far off between two way points of a defined track, based on following the sequence of way points, the opponent service application will send an off track message. This will alert the end-user that she is off track. She may then try to correct her way to get back on the track.

In a specific embodiment, the opponent service provides real-time information on others also participating in the match. In this case, GPS enabled mobile terminals are connected to the application server in e.g. a GSM or UMTS network that maintains the locations and performance of others (that are also connected via a GPS mobile device to the application server).

It should be noted that instead of implementing the invention in an application server of an Intelligent network (IN) other implementations are possible like an IMS implementation as will be known to the skilled person.

The present invention has been explained above with reference to a number of exemplary embodiments. As will be apparent to the person skilled in the art, various modifications and amendments can be made without departing from the scope of the present invention, as defined in the appended claims.

1-22. (canceled)

23. Application server for use in a mobile communication network, said application server comprising:
Means for receiving track information of a track to be travelled by a racer carrying a first mobile terminal, said track information comprising way points of said track;
Means for receiving real time position information on positions of said first mobile phone;
Means for calculating a distance traveled since a starting time for the first mobile phone using said received real time position information and said track information;
Means for comparing said distance traveled with a distance traveled by a competitor to render a relative distance travelled;
Means for sending feedback information during a race to said first mobile phone relating to said relative distance travelled.

24. Application server according to claim 23, wherein said position information on positions of said first mobile phone are received from said first mobile phone.

25. Application server according to claim 23, wherein said position information on positions of said first mobile phone are received from a positioning server.

26. Application server according to claim 23, wherein said feedback information is given in audio beeps expressing the relative distance.

27. Application server according to claim 26, wherein said audio beeps have an audio frequency depending on the value of said relative distance travelled.

28. Application server according to claim 23, wherein said application server is also arranged to send race information to a remote billboard.

29. Application server according to claim 23, wherein said application server is arranged to store track performance information of tracks traveled by said first mobile station.

30. Application server according to claim 29, wherein said track performance information is stored as distance traveled as a function of time lapsed since said starting time.

31. Application server according to claim 29, wherein said track performance information is stored as time lapsed since said starting time as a function of distance traveled.

32. Application server according to claim 23, wherein said application server is arranged to store track performance information of a plurality of tracks traveled by one or more mobile stations.

33. Application server according to claim 23, wherein said application server is arranged to send countdown information to said first mobile phone indicating a start sequence.

34. Application server according to claim 23, wherein said application server is arranged to receive a trigger from said first mobile phone and arranged to send said countdown information on receiving said trigger.

35. Application server according to claim 23, wherein said application server is arranged to recognize that said first mobile phone is at a starting point of a race, and that said application server is arranged to initiate said sending of said countdown information as soon as said first mobile phone is spotted at said starting point.

36. Application server according to claim 23, wherein said application server is arranged to recognize that said first mobile phone is at a finish point of a race, and that said application server is arranged to sending of a finish result feedback message to said first mobile phone.

37. Application server according to claim 23, wherein said application server is arranged to calculate a distance between said position of the phone and a defined track, and arranged to send an off track message to the first mobile phone to alert the end-user.

38. Application server according to claim 29, wherein said application server is arranged to calculate said relative distance using a reverse track, said reverse track comprising information of said stored track but in a reverse order.

39. Method of executing a mobile service on an Application server of a mobile communication network, said method comprising:
receiving track information of a track to be travelled by a racer carrying a first mobile terminal said track information comprising way points of said track;
receiving position information on positions of said first mobile phone;
calculating a distance traveled since a starting time for the first mobile phone using said received real time position information and said track information;
comparing said distance traveled with at least one distance traveled by a competitor to render a relative distance;
sending feedback information during a race to said first mobile phone relating to said relative distance.

40. Method for keeping track of competitors during a race, said method comprising:
receiving track information of a track to be travelled by a racer carrying a first mobile terminal said track information comprising way points of said track;
receiving real time position information on positions of a first mobile phone carried by a racer during the race;
calculating a distance traveled since a starting time of the race for the first mobile phone using said received real time position information and said track information;
comparing said distance traveled with at least one distance traveled by a competitor to render a relative distance travelled;
sending feedback information to said first mobile phone relating to said relative distance travelled, during a race.
